(19) United States
(12) Patent Application Publication
(10) Pub. No.: US 2007/0064275 A1
(43) Pub. Date: Mar. 22, 2007

(54) Apparatus and method for compressing images

(75) Inventor: Hyung-soo Ohk, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/498,754

(22) Filed: Aug. 4, 2006

(30) Foreign Application Priority Data
Sep. 22, 2005 (KR) 2005-88215

(51) Int. Cl. H04N 1/41

(52) U.S. Cl. 358/426.01

(57) ABSTRACT

An image compressing apparatus, including an image component dividing unit to divide an input image into a mask component, a foreground component, and a background component, a mask encoding unit to compress the mask component and to output mask component data, a foreground encoding unit to compress the foreground component and to output foreground component data, a background encoding unit to segment the background component into a plurality of segments, to respectively compress the segments at sampling rates in response to gradients of the respective segments, and to output the compressed background component data, segmentation information and sampling rate information, and a bit stream output unit to combine the mask component data, the foreground component data, the compressed background component data, the segmentation information and the sampling rate information to output the combined result as a bit stream.

### CROSS-REFERENCE TO RELATED APPLICATION

This application claims the benefit of Korean Application No. 2005-88215, filed Sep. 22, 2005 in the Korean Intellectual Property Office, the disclosure of which is incorporated herein by reference.

### BACKGROUND OF THE INVENTION

1. Field of the Invention

An aspect of the present invention relates to an apparatus and method of compressing an image, and, more particularly, to an apparatus and method of compressing a foreground component or a background component constructing an image, which adaptively allocates a degree of reduction of color information to a plurality of segments constructing the foreground component or background component and compresses the foreground component or background component, thereby obtaining high compression efficiency.

2. Description of the Related Art

A document image may include characters and pictures. In this case, it is inefficient to apply one compression method to both the characters and pictures in terms of compression efficiency when the document image is compressed because image quality may be deteriorated. This is because important components of a character may be different from that of a picture. For example, pixel position information is important in the case of character compression and pixel color information is important in the case of picture compression. Here, a 1-bit compression method such as MR, MH, MMR, JBIG and JBIG2 is suitable for the pixel position information and a compression method such as JPEG and JP2K is suitable for the pixel color information. MRC (Mixed Raster Contents) compression is set as a standard compression method in ITU T.44 and is also disclosed in U.S. Patent Publication No. 2003-202697, entitled, “Segmented layered image system.”

FIG. 1 illustrates a document image including a mask component, a foreground component and a background component. The left document image of FIG. 1 comprises the foreground component, mask component and background component. A foreground layer corresponds to a character, that is, a color part of the mask component, and a mask layer includes position information of a character or a chart. A background layer includes picture information. The MRC compression applies different compression methods to these three layers.

Generally, position information, which is an important component of the mask layer, is compressed in the original resolution. Color information, which is an important component of the foreground layer and background layer, is sampled and compressed with a resolution that is lower than the original resolution. A conventional method of compressing a foreground and a background samples color information at one sampling rate to compress each.

However, it is inefficient to sample the foreground and background at one sampling rate because the foreground and background include a plurality of objects or segments having different gradients or importance.

### SUMMARY OF THE INVENTION

Aspects of the present invention provides an apparatus and method for compressing a foreground component or a background component constructing an image, which adaptively allocates a degree of reduction of color information to a plurality of segments constructing the foreground component or background component and compresses the foreground component or background component so as to obtain high compression efficiency.

According to an aspect of the present invention, there is provided an image compressing apparatus, including an image component dividing unit to divide an input image into a mask component, a foreground component, and a background component, a mask encoding unit to compress the mask component and to output mask component data, a foreground encoding unit to compress the foreground component and to output foreground component data, a background encoding unit to segment the background component into a plurality of segments, to respectively compress the segments at sampling rates in response to gradients of the respective segments, and to output the compressed background component data, segmentation information and sampling rate information, and a bit stream output unit to combine the mask component data, the foreground component data, the compressed background component data, the segmentation information and the sampling rate information to output the combined result as a bit stream.

According to an aspect of the invention, the background encoding unit may include a first segmentation unit to segment the background component into a plurality of segments and to output the segments and segmentation information, a first sampling rate determining unit to calculate gradients of the plurality of segments, to determine sampling rates in response to the calculated gradients, and to output the determined sampling rates, and a first sampling and encoding unit to respectively compress the plurality of segments at the determined sampling rates.

According to an aspect of the invention, the first segmentation unit may segment the background component into a lattice or stripe pattern having a predetermined size. The first segmentation unit may extract at least one object from the background component and segments the background component into the object and the other part. The first sampling rate determining unit may calculate gradients of the respective segments and determine sampling rates proportional to the calculated gradients.

According to an aspect of the invention, the foreground encoding unit may segment the foreground component into a plurality of segments, compress the segments at sampling rates in response to gradients of the respective segments, and output compressed foreground component data, segmentation information and sampling rate information. The first segmentation unit may include a second segmentation unit to segment the foreground component into a plurality of segments and outputting the segments and segmentation information, a second sampling rate determining unit to calculate gradients of the plurality of segments, to determine sampling rates in response to the calculated gradients, and to output the determined sampling rates, and a second sampling and encoding unit to respectively compress the plurality of segments at the determined sampling rates.

According to another aspect of the present invention, there is provided an image compressing method, comprising dividing an input image into a mask component, a foreground component and a background component, compressing the mask component, the foreground component and the background component to generate mask component data, foreground component data and background component data, combining the mask component data, the foreground component data, the background component data, wherein the compressing of the mask component, the foreground component and the background component segments the background component into a plurality of segments and compresses the segments at sampling rates in response to gradients of the respective segments, respectively, to generate compressed background component data, segmentation information and sampling rate information.

According to an aspect of the invention, the compressing of the mask component, the foreground component and the background component may include segmenting the background component into a plurality of segments and outputting the segments and segmentation information, calculating gradients of the plurality of segments and determining sampling rates in response to the calculated gradients, and respectively compressing the plurality of segments at the determined sampling rates.

According to an aspect of the invention, the segmenting of the background component may segments the background component into a lattice or stripe pattern having a predetermined size. The segmenting of the background component may extract at least one object from the background component and segment the background component into the object and the other part.

According to an aspect of the invention, the calculating of gradients of the plurality of segments may comprise calculating of gradients of the respective segments and determine sampling rates proportional to the calculated gradients.

According to an aspect of the invention, the compressing of the mask component, the foreground component and the background component may segment the foreground component into a plurality of segments and compress the segments at sampling rates in response to gradients of the respective segments to generate compressed foreground component data, segmentation information and sampling rate information. The compressing the mask component, the foreground component and the background component may include segmenting the foreground component into a plurality of segments and outputting the segments and segmentation information, calculating gradients of the plurality of segments and determining sampling rates in response to the calculated gradients, and respectively compressing the plurality of segments at the determined sampling rates.

According to an aspect of the invention, a data compressing apparatus includes a dividing unit to divide input data into first, second and third components; a first unit to compress the first component and to output first component data; a second unit to compress the second component and to output second component data; a third unit to segment the third component into a plurality of segments, to respectively compress the segments at sampling rates in response to gradients of the respective segments, and to output the compressed third component data, segmentation information and sampling rate information; and a combining unit to combine the first component data, the second component data, the compressed third component data, the segmentation information and the sampling rate information.

According to an aspect of the invention, the combining unit comprises an output unit to output a result of the combination of the first component data, the second component data, the compressed third component data, the segmentation information and the sampling rate information.

According to an aspect of the invention, the first component is a mask component of an image, the second component is a foreground component of the image, and the third component is a background component of the image.

According to an aspect of the invention, the second component is a mask component of an image, the third component is a foreground component of the image, and the first component is a background component of the image.

According to an aspect of the invention, the third component is a mask component of an image, the first component is a foreground component of the image, and the second component is a background component of the image.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a document image including a mask component, a foreground component and a background component;

FIG. 2 illustrates a background layer of FIG. 1;

FIG. 3 is a block diagram of an image compressing apparatus according to an embodiment of the present invention;

FIG. 4 is a block diagram of a background encoding unit of FIG. 3;

FIG. 5 is a diagram for explaining the operation of the background encoding unit of FIG. 4;

FIG. 6 is a block diagram of a foreground encoding unit of FIG. 3;

FIG. 7 is a flow chart showing the operation of the image compressing apparatus according to an embodiment of the present invention;

FIG. 8 is a flow chart showing the process of encoding a background component in the operation 710 of FIG. 7; and

FIG. 9 is a flow chart showing the process of encoding a foreground component in the operation 710 of FIG. 7.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

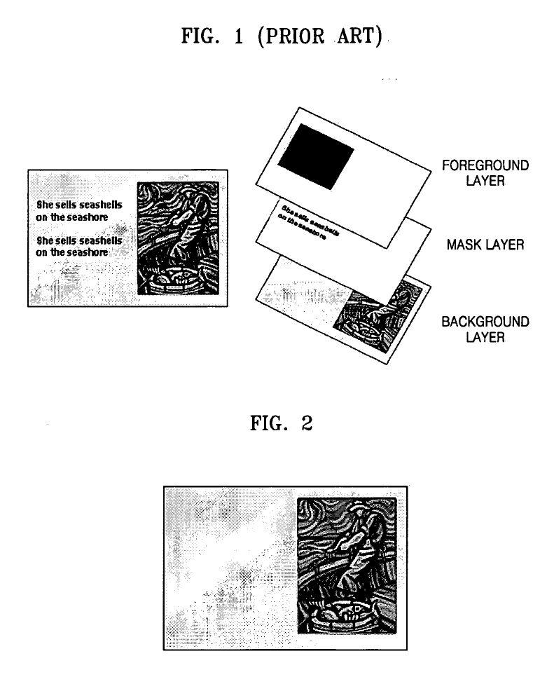

FIG. 2 illustrates the background layer of FIG. 1. As shown in FIG. 2, the background layer includes a part having a high complexity (that is, a high gradient), and a part having a low gradient. Aspects of the present invention do not sample the background layer at one sampling rate, but sample the background at sampling rates suitable for gradients of respective segments constructing the background layer. That is, the left part of the background of FIG. 2 is sampled at a low sampling rate to be compressed because image quality is slightly deteriorated even when a reduction rate is increased. Meanwhile, the right part, having the high gradient, is sampled at a high sampling rate to be compressed.

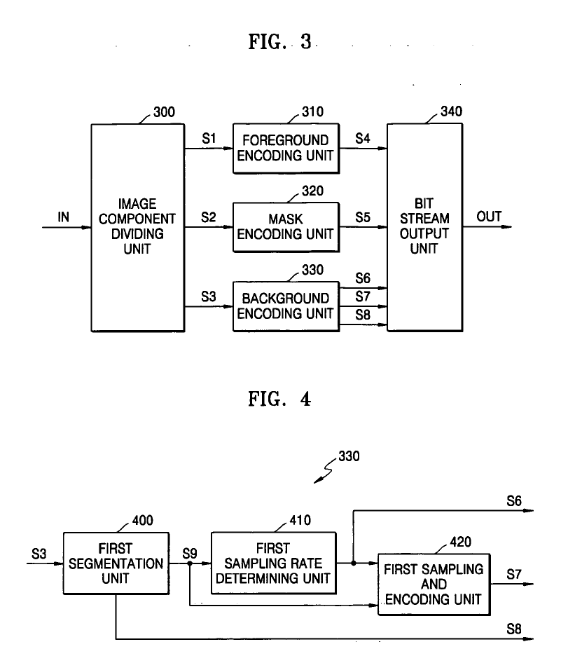

FIG. 3 is a block diagram of an image compressing apparatus according to an embodiment of the present invention. The image compressing apparatus includes an image component dividing unit 300, a foreground encoding unit 310, a mask encoding unit 320, a background encoding unit 330, and a bit stream output unit 340. The image component dividing unit 300 divides an input image IN into a foreground component S1, a mask component S2, and a background component S3 and respectively provides each to the foreground encoding unit 310, the mask encoding unit 320 and background encoding unit 330.

The foreground encoding unit 310 compresses the foreground component S1 received from the image component dividing unit 300 and outputs foreground component data S4. The mask encoding unit 320 compresses the mask component S2 received from the image component dividing unit 300 and outputs mask component data S5.

The background encoding unit 330 segments the background component S3, received from the image component dividing unit 300, into a plurality of segments. The background encoding unit 230 compresses the segments constructing the background component S3 at sampling rates in response to gradients of the respective segments, and outputs compressed background component data S6, segmentation information S7 and sampling rate information S8.

The bit stream output unit 340 combines the foreground component data S4, mask component data S5, background component data S6, segmentation information S7 and sampling rate information S8 to output the combined result as a bit stream OUT.

A decoding stage (not shown) extracts the foreground component data, mask component data, background component data, segmentation information and sampling rate information from the bit stream OUT, decodes the foreground component data and the mask component data using a predetermined decoding method, decodes the plurality of segments of the background component data according to the segmentation information and sampling rate information, and combines the decoded segments. That is, the background data encoded in a resolution that is lower than resolution of the original image is decoded into an image having the original resolution by using interpolation and decoding algorithms. The mask component, foreground component and background component, which are decoded through the aforementioned process, are combined to restore the original image. The bit stream can be transmitted between the encoding stage and the decoding stage using one or more networks and/or through recording on a storage medium.

FIG. 4 is a block diagram of the background encoding unit 330 of FIG. 3. The background encoding unit 330 includes a first segmentation unit 400, a first sampling rate determining unit 410, and a first sampling and encoding unit 420. The first segmentation unit 400 segments the background component S3 into a plurality of segments and outputs the segments S9 and segmentation information S8. Here, the first segmentation unit 400 employs a method of segmenting the background component S3 into a lattice or a striped pattern having a predetermined size or a method of extracting at least one object from the background component S3 and segmenting the background component S3 into the extracted object and the other part. The first segmentation unit 400 may use other segmentation methods in addition to or instead of the example lattice or striped pattern. The segmentation information S8 includes information about segmentation of the background component S3. When the background component S3 is segmented by a method previously set in the encoding stage and decoding stage, for example, the background component S3 is segmented into a lattice having a predetermined size, the bit stream output unit 340 does not need to provide the segmentation information S8 to the decoding stage such that the segmentation information S8 need not be output in all aspects of the invention.

While not required in all aspects, the predetermined size of the lattice or the striped pattern is a design parameter chosen by taking into consideration the number of segments and the quantity of compressed data per segment. Specifically, as the segmenting size increases, the sampling rate of each segment increases since each segment has a higher gradient. Thus, when the segmenting size increases, the data of each segment becomes more compressed, but the number of segments to be compressed decreases. Thus, the predetermined size of the background component to be segmented taking into consideration the number of segments and the quantity of compressed data per segment.

The first sampling rate determining unit 410 calculates gradients of the plurality of segments S9, determines sampling rates in response to the calculated gradients, and outputs the determined sampling rates S6. The first sampling rate determining unit 410 determines sampling rates in proportion to the gradients calculated for the respective segments S9. An example of a method of calculating gradients obtains a gradient of each segment to determine whether a variation in the segment is severe.

The first sampling and encoding unit 420 samples the plurality of segments S9 at the determined sampling rates S6 to compress them, respectively. The compressed data S7 is provided to the bit stream output unit 340.

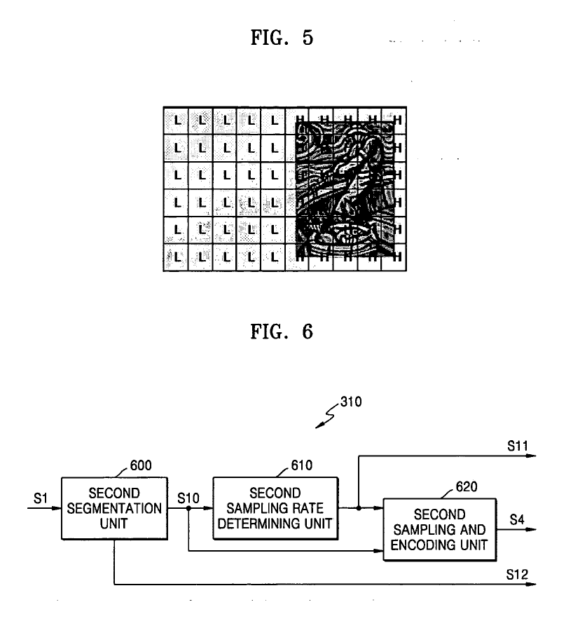

FIG. 5 is a diagram to explain the operation of the background encoding unit 330 of FIG. 4. The image of FIG. 5 is obtained by segmenting the background component of FIG. 2 into segments respectively corresponding to lattices each have 8×8 pixels. A low sampling rate is determined for the left part of the image because the left part has low gradient and a high sampling rate is determined for the right part because the right part has high gradient. More particularly, gradients of the respective segments of the image of FIG. 5 are obtained, and a high sampling rate is determined for segments having gradients larger than a predetermined threshold value, while a low sampling rate is determined for segments having gradients smaller than the predetermined threshold value. In FIG. 5, the signal “L” refers to low sampling rate segments and the signal “H” refers to high sampling rate segments. For example, the segments L are sampled at 100 dpi (dot per inch) and segments H are sampled at 200 dpi. While the image of FIG. 5 is segmented by a method of dividing the image into segments each having a predetermined shape, the segmentation method is not limited thereto. For example, a method of extracting an object having high gradient and determining a high sampling rate for the object can be employed. Moreover, while only two (2) gradients are shown, it is understood that additional gradients can be used.

Operating in a similar fashion as the background encoding unit 330, the foreground encoding unit 310 segments the foreground component S1 into a plurality of segments, compresses the respective segments at sampling rates in response to gradients of the respective segments, and outputs the compressed foreground component data S4, segmentation information (not shown) and sampling rate information (not shown) to the bit stream output unit 340. That is, the foreground component is segmented according to gradient of a color component of a character string, different sampling rates are determined for respective segments, and the segments of the foreground component are compressed at the various sampling rates. By doing so, effective foreground component compression be achieved. However, it is understood that gradient compression need not be performed for both foreground and background encoding.

FIG. 6 is a block diagram of the foreground encoding unit 310 of FIG. 3. The foreground encoding unit 310 includes a second segmentation unit 600, a second sampling rate determining unit 610 and a second sampling and encoding unit 620. The second segmentation unit 600 segments the foreground component S1 into a plurality of segments and outputs the segments S10 and segmentation information S12. The second sampling rate determining unit 410 calculates gradients of the plurality of segments S10 received from the second segmentation unit 600, determines sampling rates in response to the gradients, and outputs the determined sampling rates S11. The second sampling and encoding unit 620 respectively compresses the segments S10 at the determined sampling rates S11 and outputs the compressed data S4.

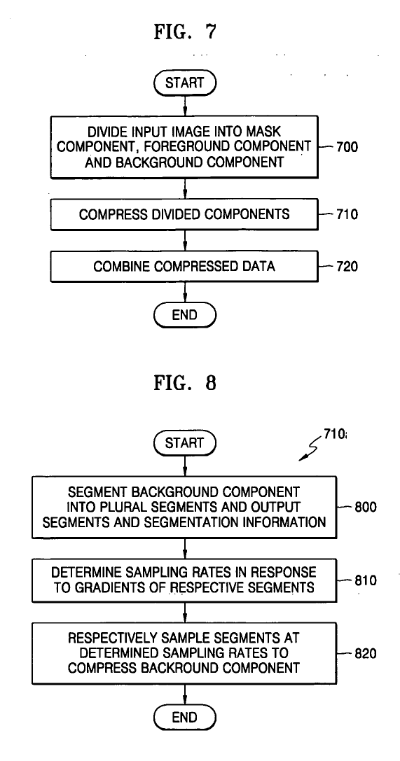

FIG. 7 is a flow chart showing the operation of the image compression apparatus according to an embodiment of the present invention. As shown in FIG. 7, the image component dividing unit 300 divides the input image IN into the foreground component S1, the mask component S2 and the background component S3 in operation 700.

The foreground component S1, the mask component S2 and the background component S3 are respectively encoded by the foreground coding unit 310, the mask coding unit 320 and the background coding unit 330 to generate the foreground component data S1, mask component data S5, sampling rate information S6, background component data S7 and segmentation data S8 in operation 710. Particularly, the background component S3 is segmented into a plurality of segments and compressed at sampling rates in response to gradients of the respective segments to generate the compressed background component data S7, segmentation information S8 and sampling rate information S6. Similarly, a segmentation of the foreground component S1 into a plurality of segments and a compression of the segments at sampling rates in response to gradients of the respective segments so as to generate the compressed foreground component data, segmentation information and sampling rate information is possible.

The foreground component data S4, mask component data S4, sampling rate information S6, background component data S7 and segmentation information S8 are combined by the bit stream output unit 340 to generate the bit stream OUT corresponding to finally encoded video data. While described as video data, it is understood that the bit stream OUT can further include audio and/or other data, and that the video data can include still and moving image data.

FIG. 8 is a flow chart showing the process of encoding the background component in operation 710 of FIG. 7. As shown in FIG. 8, the background component S3 is segmented by the first segmentation unit 400 into a plurality of segments to generate segments S9 and segmentation information S8 in operation 800. Examples of segmentation methods include a method of segmenting the background component S3 into a lattice or a striped pattern having a predetermined size and a method of extracting at least one object from the background component S3 and segmenting the background component S3 into the extracted object and the other part. Particularly, when the former is used, the bit stream output unit 340 does not output the segmentation information S8 because the decoding stage does not require the segmentation information S8.

The first sampling rate determining unit 410 calculates gradients of the plurality of segments S9 and determines the sampling rates S6 in response to the gradients in operation S810. That is, gradients are calculated for the respective segments S9 and sampling rates in proportion to the calculated gradients are determined.

The first sampling and encoding unit 420 respectively samples and compresses the segments S9 at the sampling rates S6 to generate the background component data S7 that is compressed data.

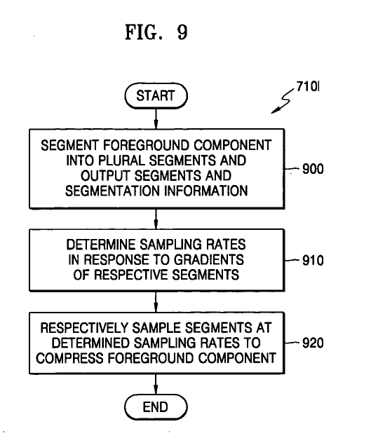

FIG. 9 is a flow chart showing the process of encoding the foreground component in the step 710 of FIG. 7. Referring to FIG. 9, the foreground component S1 is segmented by the second segmentation unit 600 into a plurality of segments S10. Thus, the segments S10 and segmentation information S12 are generated in operation 900. Segmentation is carried out using the aforementioned background component segmentation methods.

The second sampling rate determining unit 610 calculates gradients of the plurality of segments S10 and determines sampling rates S11 in response to the gradients in operation S910. The second sampling and encoding unit 620 respectively samples and compresses the segments S10 at the sampling rates S11 to generate the foreground component data S4 that is compressed data.

According to another embodiment of the invention, an image compressing method, comprises dividing an input image into a mask component, a foreground component and a background component, compressing the mask component, the foreground component and the background component to generate mask component data, foreground component data and background component data, and combining the mask component data, the foreground component data, the background component data. The compressing of the mask component, the foreground component and the background component comprises segmenting at least one of the mask component, the foreground component and/or the background component into a plurality of segments and compressing the segments at sampling rates in response to gradients of the respective segments, respectively, to generate compressed component data, segmentation information and sampling rate information.

Aspects of the invention may be embodied as computer readable codes on a computer readable recording medium. The computer readable recording medium is any data storage device that stores data which may be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium may also be distributed over network coupled computer systems so that the computer readable code is stored and executed in a distributed fashion. Also, functional programs, codes, and code segments to accomplish the present invention may be easily construed by programmers skilled in the art to which the present invention pertains.

According to aspects of the present invention, in compression of a foreground component or a background component constructing an image, a degree of reduction of color information is adaptively allocated to a plurality of segments constructing the foreground component or background component to obtain high compression efficiency.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image compressing apparatus, comprising:
an image component dividing unit to divide an input image into a mask component, a foreground component, and a background component;
a mask encoding unit to compress the mask component and to output mask component data;
a foreground encoding unit to compress the foreground component and to output foreground component data;
a background encoding unit to segment the background component into a plurality of segments, to respectively compress the segments at different sampling rates according to gradients of the respective segments, and to output the compressed background component data, segmentation information and sampling rate information; and
a bit stream output unit to combine the mask component data, the foreground component data, the compressed background component data, the segmentation information and the sampling rate information to output the combined result as a bit stream.

2. The image compressing apparatus of claim 1, wherein the background encoding unit comprises:
a first segmentation unit to segment the background component into a plurality of segments and to output the segments and segmentation information;
a first sampling rate determining unit to calculate gradients of the plurality of segments, to determine sampling rates in response to the calculated gradients, and to output the determined sampling rates; and
a first sampling and encoding unit to respectively compress the plurality of segments at the determined sampling rates.

3. The image compressing apparatus of claim 2, wherein the first segmentation unit segments the background component into a lattice or stripe pattern having a predetermined size.

4. The image compressing apparatus of claim 2, wherein the first segmentation unit extracts at least one object from the background component and segments the background component into the object and another part.

5. The image compressing apparatus of claim 2, wherein the first sampling rate determining unit calculates the gradients of the respective segments and determines sampling rates proportional to the calculated gradients for each respective segment.

6. The image compressing apparatus of claim 1, wherein the foreground encoding unit segments the foreground component into a plurality of segments, compresses the segments at the corresponding sampling rates in response to gradients of the respective segments, and outputs compressed foreground component data, segmentation information and sampling rate information.

7. The image compressing apparatus of claim 6, wherein the first segmentation unit comprises:
a second segmentation unit to segment the foreground component into a plurality of segments and to output the segments and segmentation information;
a second sampling rate determining unit to calculate gradients of the plurality of segments, to determine sampling rates in response to the calculated gradients, and to output the determined sampling rates; and
a second sampling and encoding unit to respectively compress the plurality of segments at the determined sampling rates.

8. An image compressing method, comprising:
dividing an input image into a mask component, a foreground component and a background component;
compressing the mask component, the foreground component and the background component to generate mask component data, foreground component data and background component data;
combining the mask component data, the foreground component data, the background component data, wherein the compressing of the mask component, the foreground component and the background component comprises segmenting the background component into a plurality of segments and compressing the segments at sampling rates in response to gradients of the respective segments, respectively, to generate compressed background component data, segmentation information and sampling rate information.

9. The image compressing method of claim 8, wherein the compressing of the mask component, the foreground component and the background component comprises:
segmenting the background component into a plurality of segments and outputting the segments and segmentation information;
calculating gradients of the plurality of segments and determining sampling rates in response to the calculated gradients; and
respectively compressing the plurality of segments at the determined sampling rates.

10. The image compressing method of claim 9, wherein the segmenting of the background component segments the background component into a lattice or stripe pattern having a predetermined size.

11. The image compressing method of claim 9, wherein the segmenting of the background component extracts at least one object from the background component and segments the background component into the object and the other part.

12. The image compressing method of claim 9, wherein the calculating of the gradients of the plurality of segments calculates gradients of the respective segments and determines sampling rates proportional to the calculated gradients.

13. The image compressing method of claim 8, wherein the compressing of the mask component, the foreground component and the background component segments the foreground component into a plurality of segments and compresses the segments at sampling rates in response to gradients of the respective segments to generate compressed foreground component data, segmentation information and sampling rate information.

14. The image compressing method of claim 8, wherein the compressing of the mask component, the foreground component and the background component comprises:
segmenting the foreground component into a plurality of segments and outputting the segments and segmentation information;
calculating gradients of the plurality of segments and determining sampling rates in response to the calculated gradients; and
respectively compressing the plurality of segments at the determined sampling rates.

15. A computer readable recording medium storing a program executing the method of claim 8.

16. An image compressing method, comprising:
dividing an input image into a mask component, a foreground component and a background component;
compressing the mask component, the foreground component and the background component to generate mask component data, foreground component data and background component data; and
combining the mask component data, the foreground component data, the background component data, wherein the compressing of the mask component, the foreground component and the background component comprises segmenting at least one of the mask component, the foreground component and/or the background component into a plurality of segments and compressing the segments at sampling rates in response to gradients of the respective segments, respectively, to generate compressed component data, segmentation information and sampling rate information.
